(19) United States
(12) Patent Application Publication
(10) Pub. No.: US 2011/0027539 A1
(43) Pub. Date: Feb. 3, 2011

(54) IMPROVED PROCESS FOR PRESSURELESS CONSTRAINED SINTERING OF LOW TEMPERATURE CO-FIRED CERAMIC WITH SURFACE CIRCUIT PATTERNS

(75) Inventors: Carl B Wang, Raleigh, NC (US); Michael Arnett Smith, Wake Forest, NC (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/304,218

(22) PCT Filed: Jun. 13, 2007
(86) PCT No.: PCT/US07/13963

§ 371 Date: Aug. 17, 2010

Related U.S. Application Data
(60) Provisional application No. 60/814,155, filed on Jun. 16, 2006.

(51) Int. Cl. B32B 3/08; B32B 37/02; B29C 65/02; B32B 18/00

(52) U.S. Cl. 428/174; 156/89.11

(57) ABSTRACT

This invention relates to a process which produces crack-free, non-camber, distortion-free, zero-shrink, LTCC bodies, composites, modules or packages from precursor green (unfired) laminates of multilayer structure with one or more different dielectric tape chemistries that are patterned with co-fireable thick film circuitry materials such as conductor, via fill, capacitor, inductor, or resistor for each tape layer including both top and bottom surface tape layers in direct contact with the sacrificial release tape.

### FIELD OF THE INVENTION

The present invention relates to an improved method of formation of a low temperature co-fired ceramic (LTCC) structure.

### TECHNICAL BACKGROUND OF THE INVENTION

An interconnect circuit board or package is the physical realization of electronic circuits or subsystems from a number of extremely small circuit elements electrically and mechanically interconnected. It is frequently desirable to combine these diverse type electronic components in an arrangement so that they can be physically isolated and mounted adjacent to one another in a single compact package and electrically connected to each other and/or to common connections extending from the package.

Complex electronic circuits generally require that the circuit be constructed of several levels of conductors separated by corresponding insulating dielectric tape layers. The conductor layers are interconnected through the dielectric layers that separate them by electrically conductive pathways, called via fills.

In all subsequent discussion it is understood that the use of the term tape layer or dielectric layer implies the presence of metallizations both surface conductor and interconnecting via fills which are cofired with the ceramic tape. In a like manner the term laminate or composite implies a collection of metallized tape layers that have been pressed together to form a single entity.

The use of a ceramic-based green tape to make LTCC multilayer circuits was disclosed in U.S. Pat. No. 4,654,095 to Steinberg. The co-fired, free sintering process offered many advantages over previous technologies. However, when larger circuits were needed, the variation of firing shrinkage along the planar or x,y direction proved too broad to meet the needs. Given the reduced sizes of the current generation of surface mount components, the shrinkage tolerance (reproducibility of x,y shrinkage) has proved too great to permit the useful manufacture of LTCC laminates much larger than 6″ by 6″. This upper limit continues to be challenged today by the need for greater circuit density as each generation of new circuits and packages evolves. To improve production yield while providing multiple circuit functions at a minimal physical dimension, it is often desirable to populate a massive array of modules or components on a LTCC laminate of 6″ by 6″ or larger size. In turn this translates into ever-smaller module or component sizes and thereby into smaller geometry's including narrower conductor lines and spaces and smaller vias on finer pitches in the tape. All of this requires a much lower shrinkage tolerance than could be provided practically by the free sintering of LTCC laminates.

A method for reducing X—Y shrinkage during firing of green ceramic bodies in which a release layer, which becomes porous during firing, is placed upon the ceramic body and the assemblage is fired while maintaining pressure on the assemblage normal to the body surface was disclosed in U.S. Pat. No. 5,085,720 to Mikeska. This method used to make LTCC multilayer circuits provided a significant advantage over Steinberg, as a reduction X—Y shrinkage was obtained through the pressure assisted method.

An improved co-fired LTCC process was developed and is disclosed in U.S. Pat. No. 5,254,191 to Mikeska. This process, referred to as PLAS, an acronym for pressure-less assisted sintering, placed a ceramic-based release tape layer on the two major external surfaces of a green LTCC laminate. The release tape controls shrinkage during the firing process. Since it allows the fired dimension of circuit features to be more predictable the process represents a great improvement in the fired shrinkage tolerance.

A modification of the art proposed by Mikeska is presented in U.S. Pat. No. 6,139,666 by Fasano et al. where the edges of a multilayer ceramic are chamfered with a specific angle to correct edge distortion, due to imperfect shrinkage control exerted by externally applied release tape during firing.

Shepherd proposed another process for control of registration in an LTCC structure in U.S. Pat. No. 6,205,032. The process fires a core portion of a LTCC circuit incurring normal shrinkage and shrinkage variation of an unconstrained circuit. Subsequent layers are made to match the features of the pre-fired core, which then is used to constrain the sintering of the green layers laminated to the rigid pre-fired core. The planar shrinkage is controlled to the extent of 0.8-1.2% but is never reduced to zero. For this to reason, the technique is limited to a few layers, before registration becomes unacceptable.

During the release in a tape-based constrained sintering process, the release tape acts to pin and restrain any possible shrinkage in x- and y-directions. The release tape itself does not sinter to any appreciable degree and is removed prior to any subsequent circuit manufacturing operation. Removal is achieved by one of a number of suitable procedures such as brushing, sand blasting or bead blasting.

Because of the difficulty to completely remove the said release tape after firing and the adverse effect of any residual release tape particulates to the solderability and wire bondability of the top and bottom conductors, they cannot be co-processed with the laminate using prior art methods. With advanced processing technologies, it has become easier to remove more thoroughly the release tape after firing. Furthermore, more LTCC fabricators are using nickel/gold plating to improve the solderability or wire bondability of surface conductors. These necessary steps related to the inability of prior art methods (i.e., inability to co-fire top and bottom conductors with the laminate) may only be carried as part of a post-fired strategy after firing and removal of the release tape. Furthermore, prior art methods of formation of a LTCC structure require the use of a shim in process. This shim leads to potential cracking and other issues with processing. FIGS. 1 and 2 describe prior art methods of formation of an LTCC structure which include the use of a shim.

The LTCC and release tape assembly shown in FIG. 1 for the prior art PLAS processes includes a bottom platen (104) of at least 1/16″ thick stainless steel or other suitable metallic materials, a preferable thickness range is from ⅛″ to ¼″ alignment pin (105) is attached to the bottom platen (104) and placed on the platen (104) are bottom release tape layer (102), pre-circuitized LTCC tape layers (103), top release tape layer (102), and a thin stainless steel, copper, or other suitable metallic shim plate (101) whose typical thickness is between 0.01″ and 0.02″.

FIG. 2a shows a magnified top portion of the FIG. 1 assembly with circuit features (106) patterned on the external surface of the top LTCC tape layer (103). Immediately on the top is a top release tape layer (102) in contact with a metallic shim plate (101) and the full assembly is protected in a polypropylene bag (108) for at least two times before placing in a heated water bath of an isostatic laminator. The direction (109) of pressure exerted through the heated water is illustrated and due to the stiffness of the shim plate (108), the insufficient deformation of LTCC assembly including the top release tape leaves air pockets (107) around the circuit features (106). During the subsequent furnace firing, the areas in intimate contact with the release tape were constrained in the x, y plane whereas the circuit features (106) neighboring the air pockets (107), not under the effective influence of the release tape, underwent free-sintering and created locally an unbalanced sintering stress. This resulted cracks (110) as shown in FIG. 2b. The top LTCC layer (103a), circuit features (106a), and top release tape layer (102a) all showed a thickness reduction. The air pockets (107a), although shrunk in volume or size due to the furnace firing are present in the fired assembly.

The method of the present invention allows for an improved constraining effect by the release tape layers to all areas on the external top and bottom surface of the LTCC substrate, regardless of whether they are on the blank substrate surface or a circuit pattern feature which protrudes above the surface of the blank substrate. The present invention allows for the co-firing of top and bottom surface conductors.

The current invention produces a structure exhibiting an interactive suppression of x,y shrinkage on a LTCC multilayer substrate with top and bottom surface circuit patterns including, but not limited to features made by vias, conductors, capacitors, inductors, and resistors and green laminate scribe line depressions.

### SUMMARY OF THE INVENTION

The invention concerns a method for making an LTCC structure with external surface features, comprising:
(a) providing two or more LTCC tape layers which form a sub-assembly having a top side and a bottom side, wherein at least one external surface has functional features;
(b) providing a top release tape layer and a bottom release tape layer;
(c) applying the top release tape layer to the top side of the sub-assembly, and applying the bottom release tape layer to the bottom side of the sub-assembly; forming a full assembly;
(d) providing a bottom platen, and applying the full assembly to the bottom platen, wherein the bottom release tape layer is in contact with the bottom platen;
(e) laminating the full assembly applied to the bottom platen;
(f) firing the laminated assembly; and
(g) removing the top release tape layer and the bottom release tape layer.

The invention also concerns a method of forming LTCC structures with external scribed lines, comprising:
(a) providing two or more LTCC tape layers which form a sub-assembly having a top side and a bottom side, wherein guides are present on the surface which indicate where lines will be scribed;
(b) scribing line depressions on the laminated sub-assembly, using the guides of step (a)
(c) providing a top release tape layer and a bottom release tape layer;
(d) applying the top release tape layer to the top side of the sub-assembly, and applying the bottom release tape layer to the bottom side of the sub-assembly; forming a full assembly;
(e) providing a bottom platen, and applying the full assembly to the bottom platen, wherein the bottom release tape layer is in contact with the bottom platen;
(f) laminating the full assembly applied to the bottom platen;
(g) firing the laminated assembly; and
(h) removing the top release tape layer and the bottom release tape layer.

### BRIEF DESCRIPTION OF THE DRAWINGS

FIG. 1 is a prior art illustration of generic dielectric tape arrangements collated, aligned and enclosed by a bottom platen and a top shim plate.

FIG. 2a is an illustration of the prior art conventional pressureless constrained sintering (PLAS) with the top portion of a LTCC assembly enclosed in a polypropylene bag and deformed under the applied pressure in a heated water bath of an isostatic laminator.

FIG. 2b is an illustration of the top portion of a LTCC made according to FIG. 2a and after furnace firing prior to the removal of the release tape layer.

FIG. 3a is an illustration of the arrangement of the top portion of a LTCC assembly for isostatic lamination in this invention where the top release tape layer is in direct contact with the polypropylene bag and deformed under the applied pressure in a heated water bath of an isostatic laminator.

FIG. 3b is an illustration of an alternative arrangement of FIG. 3a with a compressible rubber or plastic layer placed between the top release tape layer and the polypropylene bag.

FIG. 3c is an illustration of the top portion of a LTCC made according to FIG. 3a or 3b and after furnace firing prior to the removal of the release tape layer.

FIG. 4a is an illustration of the bottom portion of a LTCC assembly for isostatic lamination in this invention wherein a compressible rubber or plastic layer is placed between the release tape layer and the bottom platen and the whole assembly is enclosed in a polypropylene bag and pressured in a heated water bath of an isostatic laminator.

FIG. 4b is an illustration of the bottom portion of a LTCC made according to FIG. 4a and after furnace firing prior to the removal of the release tape layer.

FIG. 5a is an illustration of the arrangement of the top portion of a LTCC assembly with both external surface circuit features and scribe lines for isostatic lamination in this invention where the top release tape layer is in direct contact with the polypropylene bag and deformed under the applied pressure in a heated water bath of an isostatic laminator.

FIG. 5b is an illustration of the top portion of a LTCC made according to FIG. 5a and after furnace firing prior to the removal of the release tape layer.

### DETAILED DESCRIPTION OF THE INVENTION

The present invention relates to an improved crack-free, non-camber, distortion-free, zero-shrink, low-temperature co-fired ceramic (LTCC) bodies, composites, modules or packages from precursor green (unfired) laminates of multilayer structure with one or more different dielectric tape chemistries that are patterned with co-fireable thick film circuitry materials, such as screen printable conductors, photo-formable Fodel® conductors, via fill, capacitor, inductor or resistor for each tape layer including both top and bottom surface tape layers in direct contact with the sacrificial release tape. The method of the present invention also incorporates green laminate scribe lines on the external surfaces of tape layers in direct contact with the sacrificial release tape.

For the purpose of clarification, the group of pre-circuitized LTCC tape layers is named “sub-assembly” and the combination of the above “sub-assembly” with the top and bottom release tape layers is named “full assembly”.

One embodiment of the present invention relates to LTCC structures which have co-fired surface features. These surface features (also termed functional features herein) may include, for example, thick film conductors, capacitors, inductors, or resistors. Another aspect of the present invention relates to improvements, such as methods and processes, which make it possible to produce LTCC structures with co-fired surface features. An embodiment of the present invention relates to making LTCC structures with external surface features, using modified PLAS technology as described herein. The LTCC structures made by the described methods have eliminated cracking, positional accuracy, and desirable circuit production yield.

An embodiment of the present invention relates to scribing lines on the external surface of LTCC structures, using modified PLAS technology as described herein.

Another embodiment of the present invention relates to the formation of individual discrete LTCC circuit substrates from the scribed LTCC structures. The individual discrete LTCC circuit substrates are separated along the scribed lines on the LTCC structures. The singulation of the individual circuit substrates does not require separation using a dicing saw.

In an embodiment of the present invention, the LTCC structures made by the described methods may be used in the mass-production of arrays of smaller size LTCC circuit substrates on a large format panel. In a further embodiment, a large format panel may be approximately 6″×6″ to 10″×10″. In another embodiment, the smaller size LTCC circuit substrates have external surface features. In a further embodiment, the individual discrete LTCC circuit substrates are separated, manually or automatically, along the scribed lines on the LTCC structures. The resulting LTCC circuit substrates are flat and crack-free.

These LTCC structures with surface features have a number of desired characteristics, including: (1) A more well defined geometry of the surface circuit features because of the PLAS effect by the release tape conformed to a printed and dried circuit feature on the top LTCC tape layer of the sub-assembly. This effect is seen partly because, during the subsequent firing, the circuit feature is constrained to only shrink in the thickness direction and hence is able to maintain a well defined geometry. (2) A partial depression of surface feature into the external (top or bottom) LTCC tape layer of the sub-assembly by the isostatic lamination pressure. A SEM cross-sectional analysis can be used to demonstrate the physical effect. (3) A high degree of planarization of the surface circuit features and scribe line depressions. Other characteristics of these LTCC structures with co-fired surface features include those which do not affect the circuit performance within the LTCC circuit substrate or the connection or attachment with external circuit components and/or motherboard. Such characteristics include: (1) The presence of fired release tape particulates and the degree of that is dependent upon the method and thoroughness of the release tape removal process. (2) The presence of marks or smearing of the surface circuit features introduced during the release tape removal such as by a dry or wet burnishing process.

The described LTCC structures with co-fired surface features, and methods and processes for making them, have advantages over typical PLAS LTCC production. Some of these advantages are described above. Typical PLAS production of LTCC structures with surface features may have disadvantages, including: (1) The geometry of the post-fired surface circuit features may not be as well defined as would be desirable. This may be partially the result of the absence of restriction by the release tape during the sintering process of the post-fired circuit features which tend to sag or flow. (2) Surface features may mainly stay at the level of the top LTCC tape layer after the post-firing process since the features are not subjected to lamination like their co-fired counterparts. (3) Making an array of smaller circuit substrates on a large format panel using conventional PLAS technology may result in irregular topography and lack of planarity of the scribe line depressions. These characteristics are typically not desirable and may prohibit the subsequent screen printing of the post-fired surface features on the said panel as a whole. In order to overcome this potential limitation, additional steps may be required, such as the step of singulation and printing and firing of the thus separated manually or automatically discrete smaller size circuit substrates. These typical PLAS LTCC structures also differ from the structures of the present invention in that the surface features in the typical PLAS LTCC structures will not collect any fired release tape particulates, neither will marks or smearing be observed. This is primarily due to the removal of the release tape. Removal is done prior to the patterning of post-fired surface circuit features.

In another embodiment of the present invention, the method provides a distortion-free, crack-free, and camber-free low temperature co-fired ceramic structure comprising: (a) providing two or more LTCC tape layers with functional features wherein said LTCC tape layers form a sub-assembly; (b) provide a top release tape layer and a bottom release tape layer; (c) collate said LTCC tape layers, said top release tape layer and said bottom release layer to form a full assembly; (d) provide a bottom platen; (e) enclose said assembly in two or more bags; (f) isostatically laminate said assembly to form a laminated assembly; (g) remove said bags; (h) fire said laminated assembly; and (i) remove said top release tape layer and said bottom release tape layer.

In some embodiments of the present invention, functional features may be on the surface of the top layer of the sub-assembly and on the surface of the bottom layer of the sub-assembly. In a further embodiment, functional features may be on the surface of the top layer of the sub-assembly. In a further embodiment, functional features may not be on the bottom layer of the sub-assembly. As used herein, bottom layer is defined as the layer facing the metal platen. As used herein, top layer is defined as the layer which does not face the metal platen. As used herein, a surface of a top or bottom layer of a sub-assembly is intended to mean the external surface of the top or bottom layer of the sub-assembly; the surface that does not face other layers of the sub-assembly.

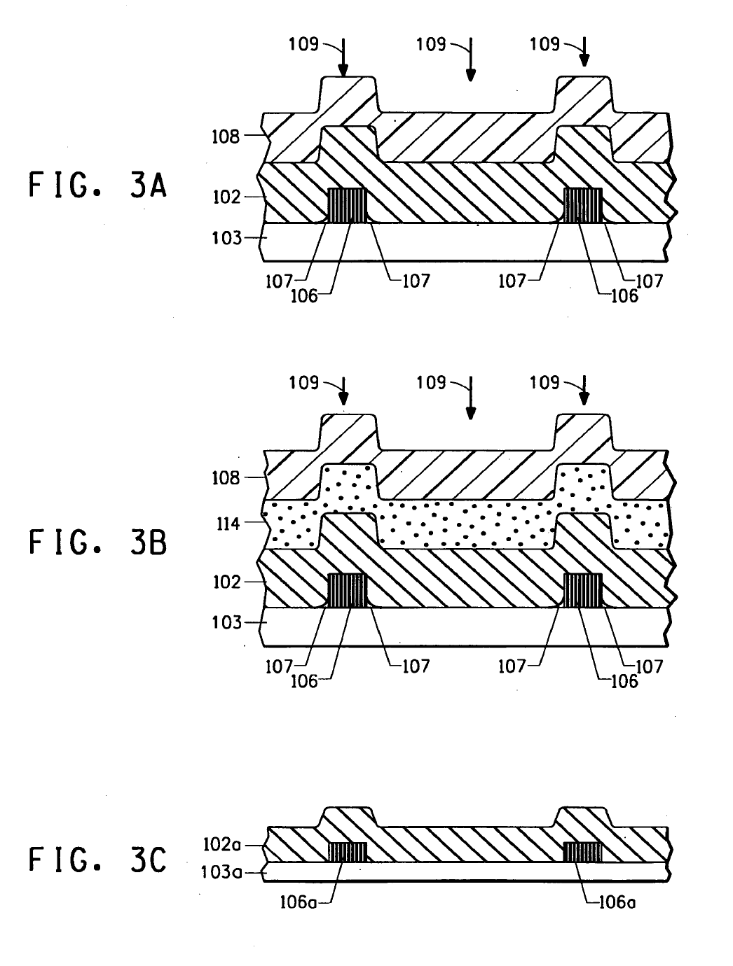

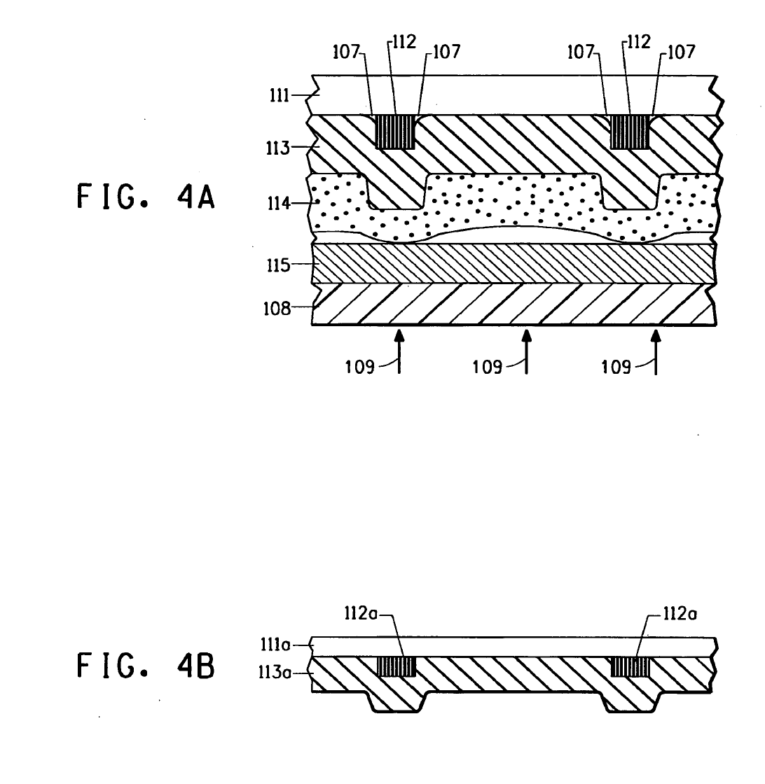

FIGS. 3A-C and 4A-B show detailed embodiments of the present invention. They are described in detail below. Those skilled in the art will understand that FIGS. 3 and 4 are demonstrative and are not intended to be limiting of the invention herein.

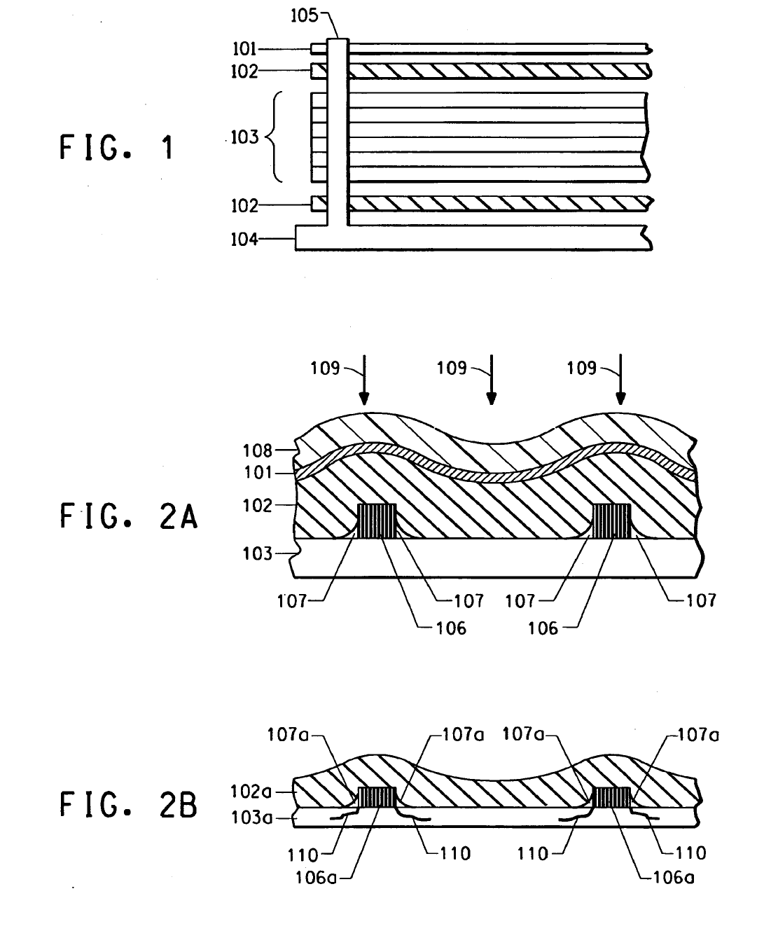

FIG. 3A shows the method of this invention wherein a magnified top portion of the LTCC assembly with circuit features (106) patterned on the external surface of the top LTCC tape layer (103) is attached to the top release tape layer (102). This full assembly is then placed and protected in a polypropylene bag (108) for at least two times before placing in a heated water bath of an isostatic laminator. The direction (109) of pressure exerted through the heated water is illustrated and, unlike the prior art processes shown in FIG. 2A, the applied pressure is sufficient to deform the polypropylene (109) with top release tape layer (102) to produce an effective conformation of release tape to the topography created by the patterned surface circuit features (106), hence leaving minimal or no air pockets (107) around.

Another configuration is shown in FIG. 3B wherein a compressible rubber or plastic layer (114) is placed on the top of the release tape layer (102) on the top of a LTCC tape layer (103) with patterned circuit features (106) before the step of polypropylene bag (108) protection. This arrangement also permits an effective conformation of release tape to the topography created by the patterned surface circuit features (106), hence leaving minimal or no air pockets (107) around.

FIG. 3C shows the schematic of a fired LTCC structure for the LTCC assemblies illustrated in both FIGS. 3A and 3B. During the subsequent furnace firing, all of the areas including the blank LTCC substrate surface (103a) and the patterned circuit features (106a) were constrained in the x, y plane since they were all in intimate contact with the release tape. Therefore, despite the sintering differential between the LTCC tape and the conductor or other materials which were used to make the circuit features, a larger constraining force overcame the sintering stress and resulted in a fired LTCC structure that is free from cracks. The top LTCC layer (103a), circuit features (106a), and top release tape layer (102a) all showed a thickness reduction.

FIG. 4A shows the improvement of this invention to the prior art processes and focuses on the bottom portion arrangement of the full LTCC assembly. The bottom-most LTCC tape layer (111) is patterned with circuit features (112) and shown in direct contact with the bottom release tape layer (113). Instead of placing directly on a bottom stainless steel or other suitable metallic platen (115), one compressible rubber or plastic layer (114) is provided as insert. The assembly is then protected in a polypropylene bag (108) for at least two times. Also shown is the direction (109) of pressure exerted through the heated water in an isostatic laminator. Although the thick platen (115) is not compressible under the applied pressure, the compressible rubber or plastic insert (114) was effectively deformed to render the bottom release tape layer (113) to conform to the topography created by the patterned surface circuit features (106), hence leaving minimal air pockets (107) around.

During the subsequent furnace firing, all of the areas including the blank LTCC substrate surface (113a) and the patterned circuit features (112a) were constrained in the x, y plane since they were all in intimate contact with the release tape. Therefore, despite the sintering differential between the LTCC tape and the conductor or other materials which were used to make the circuit features, a larger constraining force overcame the sintering stress and resulted in a fired LTCC structure that is free from cracks. The bottom LTCC layer (111a), circuit features (112a), and top release tape layer (113a) all showed a thickness reduction.

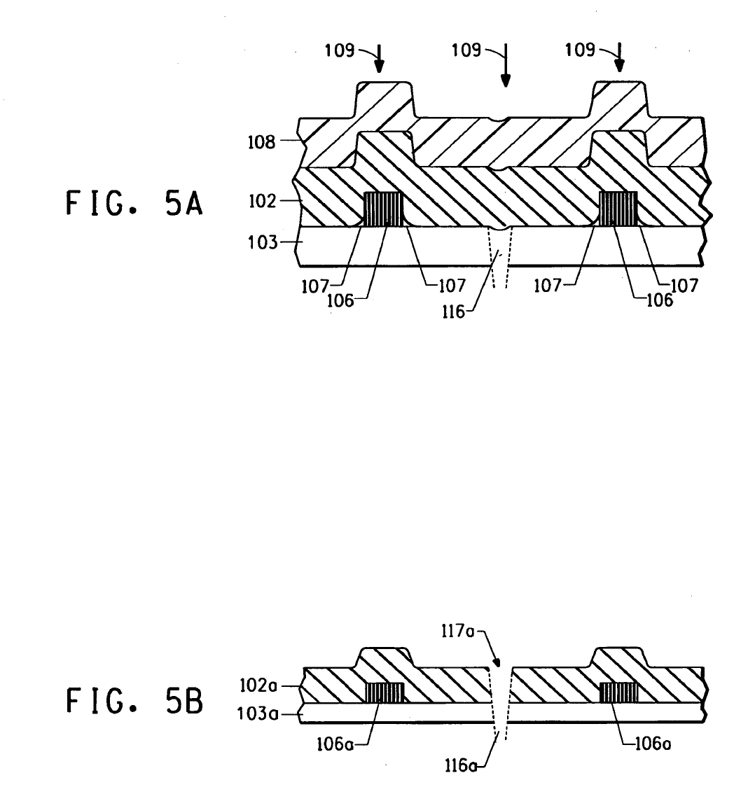

FIG. 5A shows the method of this invention wherein a magnified top portion of the LTCC assembly with circuit features (106) patterned on the external surface of the top LTCC tape layer (103) is attached to the top release tape layer (102). The difference between this assembly and the one illustrated in FIG. 3A is in the scribe line (116) shown at the center of top LTCC tape layer (103). This full assembly is then placed and protected in a polypropylene bag (108) for at least two times before placing in a heated water bath of an isostatic laminator. The direction (109) of pressure exerted through the heated water is illustrated and, unlike the prior art processes shown in FIG. 2A, the applied pressure is sufficient to deform the polypropylene (109) with top release tape layer (102) to produce an effective conformation of release tape to the topography created by the patterned surface circuit features (106) and the scribe line (116) area, hence leaving minimal or no air pockets (107) around.

FIG. 5B shows the schematic of a fired LTCC structure for the LTCC assemblies illustrated in FIG. 5A. During the subsequent furnace firing, all of the areas including the blank LTCC substrate surface (103a), the patterned circuit features (106a), and the scribe line area (116a) were constrained in the x, y plane since they were all in intimate contact with the release tape. Therefore, despite the sintering differential between the LTCC tape and the conductor or other materials, which were used to make the circuit features, a larger constraining force overcame the sintering stress and resulted in a fired LTCC structure that is free from cracks. The top LTCC layer (103a), circuit features (106a), and top release tape layer (102a) all showed a thickness reduction. Furthermore, the release tape layer (102a) shows a separation (107a) due to the stress from the sintering of LTCC tape layer (103a) and those underlying tape layers.

In one embodiment of the present invention two or more layers of glass-containing LTCC tape layers are provided with conductor circuit patterns, vias, and other functional features on each LTCC tape layer, including and not limited to the top and bottom surfaces of the LTCC tape sub-assembly. The sub-assembly is in direct contact with the sacrificial release tape layer. The release tape layer is the outermost material of the full assembly. When the full assembly is thermally processed it produces a structure exhibiting a less than 1% and preferably less than 0.2% x,y shrinkage.

A description of x,y shrinkage control by PLAS can be found in U.S. Pat. No. 5,085,720, column 4, lines 15 to 62, and in U.S. Pat. No. 6,776,861, column 1, lines 40-47. Both of these patents are incorporated herein by reference.

In an embodiment of the present invention, x,y shrinkage of less than 1% may be obtained in a further embodiment, less than 0.2% may be obtained.

In another embodiment of the present invention, the variation of shrinkage values within a production batch or among production batches is smaller than the conventional circuit substrates made by the free-sintering process. In an aspect of this embodiment, the range of shrinkage variation may be less than +/−0.15%; in a further aspect, the range of shrinkage variation may be less than +/−0.05%.

The characterization of x,y shrinkage may be done by calculating the averaged dimensional changes, of spacing among pre-punched via holes of various planar orientation on the top sheet of a group of LTCC blank or circuit substrates. The measurement of spacing can be done by the use of tool microscope, optical comparator, and other methods known to one of skill in the art. In order to account for the variation caused by the process of lamination, spacing on the top sheet based on the via hole punch file is used (with a value of a) together with the spacing of the same via hole pairs on a fired LTCC blank or circuit substrate (with a value of b) and the % shrinkage is calculated as:

100%×(a−b)/a

Currently available methods for the mass-production of arrays of smaller size LTCC circuit substrates on a large format panel such as 6″×6″ to 10″×10″ have disadvantages, including but not limited to the addition of processing steps. A typical method involves collating then laminating the LTCC circuitized layers with top and bottom release tape, firing the full-assembly, removing the release tape, and then making discrete circuit substrate by dicing saw. The dicing saw is both time consuming and the unavoidable water spraying and exposure to ceramic particulates require extra cleaning and drying steps. Typically, the scribing is done with an automatically controlled heat knife which produces scribed depression with a depth ranging from 10 to 35% and preferably at 15 to 25% of the total sub-assembly laminate thickness.

The present invention provides advantages over the current methods. In the present invention, the release tape conforms to the irregular topography along the scribed depression matrix and results in acceptable x,y shrinkage control and flat fired full-assembly. After removal of the release tape, the array of discrete LTCC circuit substrates can be produced with either manual or automatic separation along the scribed depressions. These discrete LTCC circuit substrates are flat and crack-free, as opposed to those made by typical PLAS processes. Additionally, the production yield is better than that of a typical PLAS process in which yield loss may occur due to cracks along the scribed depressions or at irregular orientation.

Various embodiments of the invention are described below. Those skilled in the art understand that multiple embodiments of the present invention are possible. The following description is merely intended to capture some embodiments and is not intended to be limiting. An LTCC assembly may be made by the following method:
a) providing individual LTCC tape layers with conductor circuit patterns, vias, and other functional features including and not limited to resistor, capacitor, and inductor materials;
b) Collating and laminating the LTCC tape layers with top and bottom release tape layers in an isostatic laminator;
c) In one embodiment the a bottom platen of at least 1/16″ thick stainless steel or other suitable metallic materials is used, a preferable thickness range is from ⅛″ to ¼″;
d) The LTCC tape layers, bottom release tape layer, and top release tape layer (i.e., the full assembly) are enclosed in a plastic bag, such as polypropylene bag, for at least 2 times,
e) To laminate in the isostatic laminator, the assembly is immersed in a water bath. The water bath temperature is determined based on the organic binder types used in the LTCC and release tape materials and may vary dependent upon the embodiment. For polyacrylate type binders, use up to 80° C. and preferably 75° C. as the temperature of the heated water bath in an isostatic laminator. For other types of polymer binders, depending on their respective glass transition temperature, heated water bath with a temperature lower than 70° C. or higher than 80° C. can also be used.
f) use up to 30 minutes and preferably 10 to 15 minutes soak time in the heated water bath of the isostatic laminator to complete the lamination process.
g) fire the above laminate in a belt or box furnace to complete the densification process after thorough organic burnout.
h) remove the release tape layers from both top and bottom sides of the LTCC assembly; and
(i) divide the fired LTCC assembly along the pre-scribed depressions into separate modules or components if necessary.

A further embodiment relates to a method of producing a distortion-free, crack-free, and camber-free low-temperature co-fired ceramic structure comprising:
(a) providing two or more LTCC tape layers with functional features wherein said LTCC tape layers form a subassembly having a top side and a bottom side;
(b) providing a top release tape layer and a bottom release tape layer;
(c) applying said top release tape layer to said top side of said subassembly and applying said bottom release tape layer to said bottom side of said subassembly;
(d) collating said LTCC tape layers, said top release tape layer and said bottom release layer to form a full assembly having a top side and a bottom side;
(e) providing a bottom platen;
(f) enclosing said full assembly in two or more bags;
(g) isostatically laminating said assembly to form a laminated assembly;
(h) removing said bags;
(i) firing said laminated assembly; and
(j) removing said top release tape layer and said bottom release tape layer; wherein said low temperature co-fired structure exhibits less than 1 percent interactive suppression of x,y shrinkage.

In an aspect of this embodiment, the LTCC tape layers are scribed with functional features after collation of said LTCC tape layers, but prior to applying said top release tape layer and said bottom release tape layer.

There are several possible embodiments of the present invention aiming for preservation of the conformation of the top and bottom release tape layers to the topography of surface circuit features, scribe lines and other similar attributes. These embodiments include but not limited to: (1) a top shim plate with engraved pattern opposite to that of the topography of the top LTCC surface features; (2) a compressible rubber or plastic layer with molded pattern opposite to that of the topography of the top LTCC surface features; and (3) a compressible rubber or plastic layer with molded pattern opposite to that of the topography of the bottom LTCC surface features. Among the above embodiments, options 2 and 3 can be produced at reasonable cost, are to provide compressible materials and hence more effective to render the conformation of the top or bottom release tape layers to the irregular surface topography of the external top or bottom circuitized and/or scribed LTCC tape layers. It is noted that the scribe lines may occur only on one, and normally top surface of the LTCC assembly.

In a further embodiment of the present invention, a film or sheet material, such as a compressible material, can be used as the top or bottom insert of the LTCC full assembly prior to the bagging step. These materials include and not limited to thermoplastic polymers, thermoset polymers, foamed polymers, unvulcanized and vulcanized rubber materials. Their degree of fitness-in-use can be estimated by the physical property of compressive strength. The compressive strength of a material is defined as its ability to withstand compression without permanent physical or structural deformation. In the present invention, the proper range of isostatic pressure is between 2,000 and 4,000 psi and preferably between 2,500 and 3.500 psi. Therefore, applicable polymeric materials with their respective compressive strength in the unit of psi provided in parenthesis include and not limited to those provided below: polypropylene (8,500-10,000), acrylic resin ((14,000-17,000), high impact acrylic resin (7,000-12,000), polystyrene ((11,500-16,000), high impact polystyrene ((8,000-16,000), poly(styrene-co-acrylonitrile) (15,000-17,500), polystyrene ABS resin (6,000-11,000), polyvinyl chloride (10,000-11,000), poly(chloro-trifluoroethylene) (6,000-12,000), Nylon 66 (5,000-13,000), Nylon 6 (4,000-11,000), acetal resin ((18,000), polycarbonate resin (12,500), polyurethane resin (20,000), cellulose acetate (2,200-10,900), cellulose acetate butyrate (2,100-9,400), and cellulose priopionate (3,000-9,600).

Another physical property that may be a measure of compressible materials useful in this invention is their durometer scale. Durometer is one of several ways to measure the hardness of a material, defined as the material's resistance to permanent indentation. The term “durometer” can refer to both the measurement, and the instrument used to generate the measurement. Durometer is typically used as a measure of hardness in polymers, elastomers, and rubbers. The two most common scales, using slightly different measurement systems, are the A and D scales. The A scale is for softer plastics, while the D scale if for harder ones as defined by the ASTM D2240-00 testing standard which includes a total of 12 scales. Each scale results in a value between 0 and 100, with higher values indicating a harder material. For this invention, by using the A scale, the applicable range is 10 to 70 with a preferred range of 25 to 55. For example, the A scale value for rubber band is 25 and that for door seal is 55, and auto tire tread is 70.

Still another embodiment of this invention is the preparation of the collated LTCC circuitized tape layers and release tape layers prior to the process of isostatic lamination. FIG. 1 shows a group of LTCC tape layers (103) located between top (102) and bottom (102) release tape layers. When making an array of smaller size modules or components on an otherwise much larger dimension LTCC platform, it is often necessary to scribe the entire large dimension LTCC platform to facilitate the singulation of individual circuit substrate after the step of furnace firing. For the purpose of providing the scribe lines, an added step of pre-lamination is required wherein all of the pre-circuitized LTCC tape layers without the release tape were subjected to a pre-lamination with lower pressure, lower temperature, or shorter time or a combination of two or all of the above.

Differences between the LTCC tape composition(s) and those of a variety of thick film pastes used to provide circuit features for various components, such as capacitors, inductors and resistors, result in sintering differentials. When the above thick film pastes were applied internally in a multilayered LTCC module or component, the sintering mismatch can be resolved by adjusting the geometry factors such as thickness, x,y dimension and/or optimizing the thick film composition. Contrasting to the above, in the cases where the above thick film pastes are used on the external surface of a multilayered LTCC module or component, because the thick film features are no longer embedded in the LTCC tape, it is necessary to assure an intimate contact of the thick film features with the release tape to render effective and nearly complete constraining. This invention provides the method to make the above happen.

In addition to the embodiments already described various other configurations and methods are possible.

For example, a method of making an LTCC structure with external surface features comprises;
(i) providing two or more LTCC tape layers which forma a sub-assembly having a top side and a bottom side, wherein at least one external surface has functional features;
(j) providing a top release tape layer and a bottom release tape layer;
(k) applying the top release tape layer to the top side of the sub-assembly, and applying the bottom release tape layer to the bottom side of the sub-assembly; forming a full assembly;
(l) providing a bottom platen, and applying the full assembly to the bottom platen, wherein the bottom release tape layer is in contact with the bottom platen;
(m) laminating the full assembly applied to the bottom platen;
(n) firing the laminated assembly; and
(o) removing the top release tape layer and the bottom release tape layer.

The described method, may further comprise, after step (d), enclosing the full assembly in two or more bags, and further comprising, after step (e), removing the bags.

Further modifications of this method include:

The described method, wherein the LTCC structure exhibits less than 1 percent interactive suppression of x,y shrinkage.

The described method, wherein the laminating type is isostatic.

The described method, further comprising, after step (a) scribing line depressions on the laminated sub-assembly.

The described method, wherein the LTCC structure exhibits less than 0.2 percent interactive suppression of x,y shrinkage.

The described method, further comprising placing a compressible sheet on the top side of said full assembly prior to enclosing the full assembly in a bag.

The described method, further comprising placing a compressible sheet on the bottom side of the full assembly placed on the platen prior to enclosing the full assembly in a bag.

The described method, wherein the functional features are capacitor(s), resistor(s), conductor(s), and/or inductor(s).

The described method, wherein the functional features are on the top surface and the bottom surface of the LTCC structure.

The described method, wherein the functional features are on the top surface of the LTCC structure.

A distortion-free, crack-free, and camber-free LTCC structure made by the described method.

Another example is a method of forming LTCC structures with external scribed lines, comprising:
(h) providing two or more LTCC tape layers which form a sub-assembly having a top side and a bottom side, wherein guides are present on the surface which indicate where lines will be scribed;
(i) scribing line depressions on the laminated sub-assembly, using the guides of step (a)
(j) providing a top release tape layer and a bottom release tape layer;
(k) applying the top release tape layer to the top side of the sub-assembly, and applying the bottom release tape layer to the bottom side of the sub-assembly; forming a full assembly;
(l) providing a bottom platen, and applying the full assembly to the bottom platen, wherein the bottom release tape layer is in contact with the bottom platen;
(m) laminating the full assembly applied to the bottom platen;
(n) firing the laminated assembly; and
(p) removing the top release tape layer and the bottom release tape layer.
   Various Modifications of this Method are Possible Including:

The described method, wherein the guides are fiducial features.

In the described method the guides may be via holes.

The described method, wherein at least one external surface of the sub-assembly of step (a) has functional features.

The described method, wherein the scribed line depressions are on the surface of the top side of the sub-assembly.

The described method, further comprising, after step (d), enclosing the full assembly in two or more bags, and further comprising, after step (e), removing the bags.

The described method, wherein the LTCC structure exhibits less than 1 percent interactive suppression of x,y shrinkage.

The described method, wherein the LTCC structure is a large panel.

The described method, wherein the large panel is 6″×6″ or larger.

The described method, wherein the large panel comprises an array of smaller sized circuits.

The described method, wherein the array of smaller sized circuits are separated by scribed line depressions.

The described method, further comprising placing a compressible sheet on the top side of said full assembly prior to enclosing the full assembly in a bag.

Components of LTCC Tapes

Typical LTCC tapes comprise glass, ceramic inorganic solids and organic medium, in which the glass and ceramic inorganic solids are dispersed. The organic medium is comprised of a polymeric binder which is dissolved in one or more volatile organic solvent(s) and, optionally, other dissolved materials such as plasticizers, release agents, dispersing agents, stripping agents, antifoaming agents, stabilizing agents and wetting agents.

Glass compositions suitable for LTCC tapes include and not limited to the following compositions detailed below. Glasses for use include, but are not limited to those listed in Table 1. In addition, the glass composition may be selected from the following oxide constituents in the compositional range of: SiO₂ 52-54, Al₂O₃ 12.5-14.5, B₂O₃ 8-9, CaO 16-18, MgO 0.5-5, Na₂O 1.7-2.5, Li₂O 0.2-0.3, SrO 0-4. K₂O 1-2 in weight %. The more preferred composition of glass being: SiO₂ 53.50, Al₂O₃ 13.00, B₂O₃ 8.50, CaO 17.0, MgO 1.00 Na₂O 2.25, Li₂O 0.25, SrO 3.00, K₂O 1.50 in weight %.

TABLE 1
(wt. %)

| Glass # | SiO₂ | Al₂O₃ | PbO | ZrO₂ | B₂O₃ | CaO | ZnO | BaO | MgO | La₂O₃ | Na₂O | Li₂O | SrO | P₂O₃ | TiO₂ | K₂O | Cs₂O | Nd₂O₃ |
|---|---|---|---|---|---|---|---|---|---|---|---|---|---|---|---|---|---|---|
| 1 | | | | | 6.08 | | | 23.12 | | | | | | 4.50 | 34.25 | | | 32.05 |
| 2 | 13.77 | | | 4.70 | 26.10 | | | 14.05 | 35.09 | | | 1.95 | | 4.34 | | | | |
| 3 | 52.00 | 14.00 | | | 9.00 | 17.50 | 3.00 | | 4.50 | | | | | | | | | |
| 4 | | | | | 11.91 | | | 21.24 | | | | 0.97 | | 4.16 | 26.95 | | 4.59 | 30.16 |
| 5 | 56.50 | 9.10 | 17.20 | | 4.50 | 8.00 | | | 0.60 | | 2.40 | | | | | 1.70 | | |
| 6 | | | | | 11.84 | | | 21.12 | | | | 1.31 | | 4.14 | 25.44 | | 6.16 | 29.99 |
| 7 | 52.00 | 14.00 | | | 8.50 | 17.50 | | | 4.75 | | 2.00 | 0.25 | | | | 1.00 | | |
| 8 | | | | | 6.27 | | | 22.79 | | | | 0.93 | | 4.64 | 33.76 | | | 31.60 |
| 9 | | | | | 9.55 | | | 21.73 | | | | 0.92 | | 4.23 | 32.20 | | 1.24 | 30.13 |
| 10 | | | | | 10.19 | | | 21.19 | | | | 0.97 | | 4.15 | 28.83 | | 4.58 | 30.08 |
| 11 | 13.67 | | | 5.03 | 25.92 | | | 13.95 | 34.85 | | | 1.94 | | 4.64 | | | | |
| 12 | 12.83 | | | 4.65 | 21.72 | | | 13.09 | 34.09 | | | 1.96 | | 11.65 | | | | |
| 13 | 13.80 | | | 4.99 | 25.86 | | | 13.45 | 33.60 | | | 2.09 | | 4.35 | | | 1.87 | |
| 14 | 52.00 | 14.00 | | | 9.00 | 17.50 | | | 5.00 | | 1.75 | 0.25 | | | | 0.50 | | |
| 15 | 53.50 | 13.00 | | | 8.50 | 17.00 | | | 1.00 | | 2.25 | 0.25 | 3.00 | | | 1.50 | | |
| 16 | 13.76 | | | 4.70 | 22.60 | | | 14.05 | 35.10 | | | 1.95 | | 7.84 | | | | |
| 17 | 54.00 | 12.86 | | | 8.41 | 16.82 | | | 0.99 | | 2.23 | 0.25 | 2.97 | | | 1.48 | | |
| 18 | 54.50 | 12.72 | | | 8.32 | 16.63 | | | 0.98 | | 2.20 | 0.24 | 2.94 | | | 1.47 | | |
| 19 | | | | | 12.35 | | | 22.02 | | | | 1.36 | | 4.32 | 26.53 | 2.15 | | 31.27 |
| 20 | | | | | 12.22 | | | 21.79 | | | | 0.85 | | 4.27 | 26.24 | 3.70 | | 30.93 |
| 21 | 8.74 | | | 2.44 | 11.77 | | | 7.30 | 2.48 | 27.55 | | 1.15 | | 4.00 | | | 6.10 | 28.45 |
| 22 | 9.36 | | | 2.62 | 12.19 | | | 7.82 | 5.09 | 19.67 | | 1.34 | | 4.28 | | | 7.15 | 30.47 |
| 23 | 7.63 | | | | 12.63 | | | 22.26 | 5.36 | 15.76 | | 1.26 | | 2.58 | | 1.99 | | 30.52 |
| 24 | | | | | 12.26 | | 9.55 | 21.59 | 4.14 | 15.29 | | 1.31 | | 4.16 | | 2.07 | | 29.62 |
| 25 | 5.66 | | | | 12.71 | | | 21.68 | 4.04 | 19.19 | | 1.41 | | 4.18 | | 1.39 | | 29.73 |

Ceramic filler such as Al₂O₃, ZrO₂, TiO₂, ZrSiO₄, BaTiO₃ or mixtures thereof may be added to the castable composition used to form the tapes in an amount of 0-50 wt. % based on solids. Depending on the type of filler, different crystalline phases are expected to form after firing. The filler can control dielectric constant and loss over the frequency range. For example, the addition of BaTiO₃ can increase the dielectric constant significantly.

Al₂O₃ is the preferred ceramic filler since it reacts with the glass to form an Al-containing crystalline phase. Al₂O₃ is very effective in providing high mechanical strength and inertness against detrimental chemical reactions. Another function of the ceramic filler is rheological control of the entire system during firing. The ceramic particles limit flow of the glass by acting as a physical barrier. They also inhibit sintering of the glass and thus facilitate better burnout of the organics. Other fillers, α-quartz, CaZrO₃, mullite, cordierite, forsterite, zircon, zirconia, BaTiO₃, CaTiO₃, MgTiO₃, SiO₂, amorphous silica or mixtures thereof may be used to modify tape performance and characteristics. It is preferred that the filler has at least a bimodal particle size distribution with D50 of the larger size filler in the range of 1.5 and 3 microns and the D50 of the smaller size filler in the range of 0.3 and 0.8 microns.

In the formulation of a LTCC tape composition, the amount of glass relative to the amount of ceramic material is important. A filler range of 20-40% by weight is considered desirable in that the sufficient densification is achieved. If the filler concentration exceeds 50% by wt., the fired structure is not sufficiently densified and is too porous. Within the desirable glass/filler ratio, it will be apparent that, during firing, the liquid glass phase will become saturated with filler material.

For the purpose of obtaining higher densification of the composition upon firing, it is important that the inorganic solids have small particle sizes. In particular, substantially all of the particles should not exceed 15 μm and preferably not exceed 10 μm. Subject to these maximum size limitations, it is preferred that at least 50% of the particles, both glass and ceramic filler, be greater than 1 μm and less than 6 μm.

The organic medium in which the glass and ceramic inorganic solids are dispersed is comprised of a polymeric binder which is dissolved in a volatile organic solvent and, optionally, other dissolved materials such as plasticizers, release agents, dispersing agents, stripping agents, antifoaming agents, stabilizing agents and wetting agents.

To obtain better binding efficiency, it is preferred to use at least 5% wt. polymer binder for 90% wt. solids, which includes glass and ceramic filler, based on total composition. However, it is more preferred to use no more than 30% wt. polymer binder and other low volatility modifiers such as plasticizer and a minimum of 70% inorganic solids. Within these limits, it is desirable to use the least possible amount of polymer binder and other low volatility organic modifiers, in order to reduce the amount of organics which must be removed by pyrolysis, and to obtain better particle packing which facilitates full densification upon firing.

In the past, various polymeric materials have been employed as the binder for green tapes, e.g., poly(vinyl butyral), poly(vinyl acetate), poly(vinyl alcohol), cellulosic polymers such as methyl cellulose, ethyl cellulose, hydroxyethyl cellulose, methylhydroxyethyl cellulose, atactic polypropylene, polyethylene, silicon polymers such as poly(methyl siloxane), poly(methylphenyl siloxane), polystyrene, butadiene/styrene copolymer, polystyrene, poly(vinyl pyrollidone), polyamides, high molecular weight polyethers, copolymers of ethylene oxide and propylene oxide, polyacrylamides, and various acrylic polymers such as sodium polyacrylate, poly(lower alkyl acrylates), poly(lower alkyl methacrylates) and various copolymers and multipolymers of lower alkyl acrylates and methacrylates. Copolymers of ethyl methacrylate and methyl acrylate and terpolymers of ethyl acrylate, methyl methacrylate and methacrylic acid have been previously used as binders for slip casting materials.

U.S. Pat. No. 4,536,535 to Usala, issued Aug. 20, 1985, has disclosed an organic binder which is a mixture of compatible multipolymers of 0-100% wt. C₁₋₈ alkyl methacrylate, 100-0% wt. C₁₋₈ alkyl acrylate and 0-5% wt. ethylenically unsaturated carboxylic acid of amine. Because the above polymers can be used in minimum quantity with a maximum quantity of dielectric solids, they are preferably selected to produce the dielectric compositions of this invention. For this reason, the disclosure of the above-referred Usala application is incorporated by reference herein.

Frequently, the polymeric binder will also contain a small amount, relative to the binder polymer, of a plasticizer that serves to lower the glass transition temperature (Tg) of the binder polymer. The choice of plasticizers, of course, is determined primarily by the polymer that needs to be modified. Among the plasticizers which have been used in various binder systems are diethyl phthalate, dibutyl phthalate, dioctyl phthalate, butyl benzyl phthalate, alkyl phosphates, polyalkylene glycols, glycerol, poly(ethylene oxides), hydroxyethylated alkyl phenol, dialkyldithiophosphonate and poly(isobutylene). Of these, butyl benzyl phthalate is most frequently used in acrylic polymer systems because it can be used effectively in relatively small concentrations. It is noted however, that the inorganic materials including and not limited to glass(es), filler(s), and pigment(s) will have some degree of interaction with the polymeric binder(s), this generally raise its (their) glass transition temperature to counter the effect of plasticizer(s) in the tape compositions.

The solvent component of the casting solution is chosen so as to obtain complete dissolution of the polymer and sufficiently high volatility to enable the solvent to be evaporated from the dispersion by the application of relatively low levels of heat at atmospheric pressure. In addition, the solvent must boil well below the boiling point or the decomposition temperature of any other additives contained in the organic medium. Thus, solvents having atmospheric boiling points below 150° C. are used most frequently. Such solvents include acetone, xylene, methanol, ethanol, isopropanol, methyl ethyl ketone, ethyl acetate, 1,1,1-trichloroethane, tetrachloroethylene, amyl acetate, 2,2,4-triethyl pentanediol-1,3-monoisobutyrate, toluene, methylene chloride and fluorocarbons. Individual solvents mentioned above may not completely dissolve the binder polymers. Yet, when blended with other solvent(s), they function satisfactorily. This is well within the skill of those in the art. A particularly preferred solvent is ethyl acetate since it avoids the use of environmentally hazardous chlorocarbons.

In addition to the solvent and polymer, a plasticizer is used to prevent tape cracking and provide wider latitude of as-coated tape handling ability such as blanking, printing, and lamination. A preferred plasticizer is BENZOFLEX® 400 manufactured by Rohm and Haas Co., which is a polypropylene glycol dibenzoate.

### Application

A LTCC green tape for use in this invention is formed by casting a thin layer of a slurry dispersion of the glass, ceramic filler, polymeric binder and solvent(s) as described above onto a flexible substrate, heating the cast layer to remove the volatile solvent. It is preferred that the tape doesn't exceed 20 mils in thickness and preferably 1 to 10 mils. The tape is then blanked into sheets or collected in a roll form. The green tape is typically used as a dielectric or insulating material for multilayer electronic circuits. A sheet of green tape is blanked with registration holes in each corner to a size somewhat larger than the actual dimensions of the circuit. To connect various layers of the multilayer circuit, via holes are formed in the green tape. This is typically done by mechanical punching. However, a sharply focused laser can be used to volatilize and form via holes in the green tape. Typical via hole sizes range from 0.004″ to 0.25″. The interconnections between layers are formed by filling them via holes with a thick film conductive ink. This ink is usually applied by standard screen printing techniques. Each layer of circuitry is completed by screen printing conductor tracks. Also, resistor inks or high dielectric constant inks can be printed on selected layer(s) to form resistive or capacitive circuit elements. Furthermore, specially formulated high dielectric constant green tapes similar to those used in the multilayer capacitor industry can be incorporated as part of the multilayer circuitry.

After each layer of the circuit is completed, the individual layers are collated and laminated. An isostatic pressing die is used to insure precise alignment between layers. The laminates are trimmed with a hot stage cutter. Detailed description of the LTCC and release tape placement for the isostatic lamination has been provided with figure illustrations earlier. The effect and range of key lamination parameters including and not limited to pressure, time, and temperature of the liquid bath are discussed herein. Adequate pressure range between 2,500 and 3,500 psi is generally acceptable to provide sufficient contact among LTCC tape and a variety of circuit features made with thick film conductors, capacitors, inductors, and resistors while not to excessively deform the green state multilayered bodies. To provide scribe lines to facilitate the singulation of smaller size modules or components on an otherwise larger dimension LTCC platform, the step of pre-lamination is necessary wherein a much reduced pressure in the range of 500 to 1,500 psi is generally applicable. Up to 30 minutes soak time and generally a 10 minute period is used to laminate a typical LTCC substrate. For this invention, the same time range is applicable and preferably 15 to 20 minutes are used to assure sufficient or nearly complete conformation of the top and bottom release tape layers to the external surface circuit features on the top and bottom of the LTCC sub-assembly. For the purpose of this invention, the discussion of temperature is focused on an isostatic laminator equipped with water bath. To minimize undesirable evaporation loss of water in the presumably sealed system and excessive softening of the LTCC materials to be laminated, a water bath temperature up to 80° C. and generally about 70° C. is applicable. For this invention, the same temperature range is applicable and preferably 75° to 80° C. is used to assure sufficient or nearly complete conformation of the top and bottom release tape layers to the external surface circuit features on the top and bottom of the LTCC sub-assembly. It is noted that the polymer binder(s) in the LTCC tape and release tape becomes softer and more compressible or deformable when the applied temperature is closer to the effective glass transition temperature as influenced by the plasticizer(s) and inorganic materials in the LTCC tape and release tape compositions.

Firing is carried out in a standard thick film conveyor belt furnace or in a box furnace with a programmed heating cycle. This method will, also, allow top and/or bottom conductors to be co-fired as part of the constrained sintered structure without the need for using a conventional to release tape as the top and bottom layer, and the removal, and cleaning of the release tape after firing.

As used herein, the term “firing” means heating the assemblage in an oxidizing atmosphere such as air to a temperature, and for a time sufficient to volatilize (burn-out) all of the organic material in the layers of the assemblage to sinter any glass, metal or dielectric material in the layers and thus densify the entire laminate.

It will be recognized by those skilled in the art that in each of the laminating steps the layers must be accurate in registration so that the vias are properly connected to the appropriate conductive path of the adjacent functional layer.

The term “functional layer” refers to the printed green tape, which has conductive, resistive or capacitive functionality. Thus, as indicated above, a typical green tape layer may have printed thereon one or more resistor circuits and/or capacitors as well as conductive circuits.

According to the arrangement illustrated in FIGS. 1 to 5, green tape sheets of various thickness were blanked with corner registration holes into sheets with x- and y-dimensions ranging from 3″×3″ to 8″×8″. These were then punched to form via holes and then metallized with suitable surface and via fill conductors using standard processing techniques well known to those skilled in the art.

The parts were then fired by heating in an oxidizing atmosphere such as air to a temperature, and for a time sufficient to volatilize (burn-out) all of the organic material in the layers of the assemblage to sinter any glass, metal or dielectric material in the layers. In this way the entire laminate was densified.

The release tape was then removed from each part using a typical procedure of water washing, mechanical burnishing or sand blasting.

The parts were then evaluated for any shrinkage, crack or other defects, and substrate camber.

Topography Measurements

The degree of topography conformation can be estimated with a surface topography scan by using either a mechanical (i.e. stylus contact) to type or an optical type instrument. Tencor Alpha-Step 500, a typical mechanical type surface profilometer is equipped with a diamond-tip stylus of various diameter and provides a range of stylus pressure, scan speeds, and scanning modes. A maximum scan length of 10 mm and vertical topography height of 300 microns are both adequate for the characterization of topography control as described in this invention. A typical optical profiler such as Veeco's Wyko NT3300 uses a computerized Interferometric Microscope to characterize the surface profile. Generally a low magnification objective up to 5× is adequate for surface structure of a hybrid circuit in both vertical and lateral direction. For this invention, a comparison between the profile of a surface feature such as conductor pattern before and after it's been laminated with a release tape layer can be used to illustrate the effect of lamination process optimization which significantly influences the integrity of the subsequently fired LTCC structure.

What is claimed is:

1. A method of making an LTCC structure with external surface features, comprising:
(a) providing two or more LTCC tape layers which forma a sub-assembly having a top side and a bottom side, wherein at least one external surface has functional features;
(b) providing a top release tape layer and a bottom release tape layer;
(c) applying the top release tape layer to the top side of the sub-assembly, and applying the bottom release tape layer to the bottom side of the sub-assembly; forming a full assembly;
(d) providing a bottom platen, and applying the full assembly to the bottom platen, wherein the bottom release tape layer is in contact with the bottom platen;
(e) laminating the full assembly applied to the bottom platen;
(f) firing the laminated assembly; and
(g) removing the top release tape layer and the bottom release tape layer.

2. The method of claim 1, further comprising, after step (d), enclosing the full assembly in two or more bags, and further comprising, after step (a), removing the bags.

3. The method of claim 1, wherein the LTCC structure exhibits less than 1 percent interactive suppression of x,y shrinkage.

4. The method of claim 1, wherein the laminating type is isostatic.

5. The method of claim 1, further comprising, after step (a) scribing line depressions on the laminated sub-assembly.

6. The method of claim 3, wherein the LTCC structure exhibits less than 0.2 percent interactive suppression of x,y shrinkage.

7. The method of claim 2, further comprising placing a compressible sheet on the top side of said full assembly prior to enclosing the full assembly in a bag.

8. The method of claim 7, further comprising placing a compressible sheet on the bottom side of the full assembly placed on the platen prior to enclosing the full assembly in a bag.

9. The method of claim 1, wherein the functional features are capacitor(s), resistor(s), conductor(s), and/or inductor(s).

10. The method of claim 1, wherein the functional features are on the top surface and the bottom surface of the LTCC structure.

11. The method of claim 1, wherein the functional features are on the top surface of the LTCC structure.

12. A distortion-free, crack-free, and camber-free LTCC structure made by the method of claim 1.

13. A method of forming LTCC structures with external scribed lines, comprising:
(o) providing two or more LTCC tape layers which form a sub-assembly having a top side and a bottom side, wherein guides are present on the surface which indicate where lines will be scribed;
(p) scribing line depressions on the laminated sub-assembly, using the guides of step (a)
(q) providing a top release tape layer and a bottom release tape layer;
(r) applying the top release tape layer to the top side of the sub-assembly, and applying the bottom release tape layer to the bottom side of the sub-assembly; forming a full assembly;
(s) providing a bottom platen, and applying the full assembly to the bottom platen, wherein the bottom release tape layer is in contact with the bottom platen;
(t) laminating the full assembly applied to the bottom platen;
(u) firing the laminated assembly; and
(q) removing the top release tape layer and the bottom release tape layer.

14. The method of claim 13, wherein the guides are fiducial features.

15. The method of claim 13, wherein the guides are via holes.

16. The method of claim 13, wherein at least one external surface of the sub-assembly of step (a) has functional features.

17. The method of claim 13, wherein the scribed line depressions are on the surface of the top side of the sub-assembly.

18. The method of claim 13, further comprising, after step (d), enclosing the full assembly in two or more bags, and further comprising, after step (e), removing the bags.

19. The method of claim 13, wherein the LTCC structure exhibits less than 1 percent interactive suppression of x,y shrinkage.

20. The method of claim 13, wherein the LTCC structure is a large panel.

21. The method of claim 20, wherein the large panel is 6″×6″ or larger.

22. The method of claim 20, wherein the large panel comprises an array of smaller sized circuits.

23. The method of claim 22, wherein the array of smaller sized circuits are separated by scribed line depressions.

24. The method of claim 13, further comprising placing a compressible sheet on the top side of said full assembly prior to enclosing the full assembly in a bag.
